(19) United States
(12) Patent Application Publication
(10) Pub. No.: US 2009/0025576 A1
(43) Pub. Date: Jan. 29, 2009

(54) Machines for making bales of disgregated material

(75) Inventor: Lorenzo Ribas-Blanes, Sabadell (Barcelona) (ES)

Correspondence Address: STAAS & HALSEY LLP, SUITE 700, 1201 NEW YORK AVENUE, N.W., WASHINGTON, DC, 20005, US

(73) Assignee: AMADEO FARELL S.A.U., Barcelona (ES)

(21) Appl. No.: 11/878,235

(22) Filed: Jul. 23, 2007

(51) Int. Cl. B30B 13/00

(52) U.S. Cl. 100/35

(57) ABSTRACT

These improvements are applied to the machines that comprise a compacting chamber and consist in:
a.-the larger lower surface of the compacting chamber is made up of a substantially flat surface provided with runoff means.
b.-each smaller surface of the compacting chamber has, in equal conditions, a frame arrangement which, acting as an attachment flange.
c.-the output door is arranged so that is only moves in the vertical direction irrespective of whether the pressing plate has reached the stopping point.
d.-the capacity of the compacting chamber is variable according to a possible excess in the introduced mass to be compacted and
e.-the telescopic box has on at least one of its walls, bottom wall and/or roof through holes located in the proximity of the openable door.

### AIM OF THE INVENTION

This invention relates to improvements in the machines for making bales of disgregated materials, with the latter term of disgregated materials comprising urban rubbish, waste products and industrial byproducts which, once formed into compact bales, are deposited, forming stable layers, separated by layers of artificial aggregates, in dumps where the products making up said bales are biodegraded in a controllable manner or said bales are stored to be processed or incinerated subsequently.

### STATE OF THE ART

Such bales are made in horizontally arranged pressing machines that comprise a compacting chamber which, with a parallelepiped shape, on one of its medium faces receives, all over its surface, the action of a pressing plate, while on one of its smaller faces, again all over it, the action of an expulsion plate is received, either withstanding the pressure of the bale formation operation, or acting upon said bale to remove it from the compacting chamber and, finally, on another of its smaller faces, the machine has an openable door which opens in the horizontal direction when the compacted bale is expelled.

These pressing machines for making bales of disgregated materials usually have a longitudinal structure, which includes a feeding hopper for the compacting chamber and which contains the hydraulic cylinder that drives the pressing plate, at the end of which there is the compacting chamber which, according to the space where the pressing machine is to be installed, the expulsion and bale exit plate equipment, is arranged on one side or the other of said longitudinal structure. This means the machine arrangement is predetermined by the manufacturing order, and therefore the manufacturers of these pressing machines cannot mass produce said machines, and consequently they are more costly.

Moreover, when the disgregated material is wet (organic rubbish and waste) liquids are released during the pressing action which means that the chamber and its surrounding areas become damp and are inundated by these squeezed liquids, which can produce rust in the compacting chamber and a polluted atmosphere that is unsuitable for the working environment.

Also, as the openable door in the compacting chamber opens in the horizontal direction, this means that, in some cases, the material becomes partially decompacted, and consequently the bale is not acceptable and the material must be returned to the feeding hopper to be compacted again.

According to another aspect, with respect to the mass of disgregated material to be compacted in a bale, the problem arises whereby owing to the accidental interlaying of a portion of incompactible mass or the also accidental excess of introduced mass, the pressing plate cannot reach the stopping point, and consequently the process is interrupted, in which case, what normally happens is that the workers undertake the very cumbersome task of unloading the compacting chamber, which implies wasted effort and a considerable reduction in the production rate.

Finally, there is also the drawback that between one compact bale, which is at the beginning of the telescopic box, and a bale that is being expelled, a chamber of air is created which produces a variable pushing force against the former by the latter, which varies the precision of the bale strapping.

### DESCRIPTION OF THE INVENTION

In order to overcome such drawbacks, solutions have been adopted that are the object of these improvements and which are defined in the following points:

a.-the larger lower face of the compacting chamber is made up of a substantially flat surface provided with runoff means for the liquids contained in the material to be compacted and that flow during the pressing operation;

b.-each smaller face of the compacting chamber has, in equal conditions, a frame arrangement which, acting as an attachment flange, allows the compact bale expulsion equipment and the bale output equipment, comprising the telescopic shaping chamber, the strapping apparatus and the waiting station for unloading the finished bales, to be connected indifferently to the machine;

c.-the output door is arranged so that is only moves in the vertical direction irrespective of whether the pressing plate has reached the stopping point;

d.-the capacity of the compacting chamber is variable according to a possible excess in the introduced mass to be compacted, corresponding to a normal bale; and

e.-the telescopic box has on at least one of its walls, bottom wall and/or roof through holes located in the proximity of the openable door.

One characteristic of the invention consists in the runoff means for the liquids that flow from the material to be compacted owing to the effect of the pressing action, consist in a plurality of through holes in a resistant plate that forms the larger lower face of said compacting chamber.

Another characteristic of the invention is that the compact bale expulsion equipment is attached to the flange of the compacting chamber corresponding to the smaller face thereof which is located to the left of the direction in which the pressing plate moves, while the compact bale output equipment, together with the strapping apparatus thereof and the unloading station of the finished bales, is attached to the flange of said compacting chamber corresponding to the smaller face located to the right of the direction in which the pressing plate moves and opposite the expulsion equipment.

Another characteristic of the invention is that the compact bale expulsion equipment is attached to the flange of the compacting chamber corresponding to the smaller face thereof which is located to the right of the direction in which the pressing plate moves, while the compact bale output equipment, together with the strapping apparatus thereof and the unloading station for the finished bales, is attached to the flange of said compacting chamber corresponding to the smaller face located to the left of the direction in which the pressing plate moves and opposite the expulsion equipment.

Another characteristic of the invention lies in the fact that the machine, in the event excess material is detected in the compacting chamber by means of the pressure switch that prevents the pressing plate from reaching the stopping point, is provided with auxiliary means which, in the first instance, determine an increased capacity of said compacting chamber according to an expansion volume, at the cost of making the expulsion plate retract, in order to allow excess material to be fed in by driving the pressing plate until it reaches its stopping point set by end stops, at which moment the door, which closes the exit to the chamber while the material making up the bale is compacted, opens, and the expulsion plate is activated, outputting a bale that may be slightly oversized at its largest dimension.

A further characteristic of the invention is that the machine, in the event that the expansion volume created by retracting the expulsion plate is not enough to absorb the excess material, is provided with means that determine the opening of the output door and, without interrupting the action of the pressing plate, activate the expulsion plate, forming a slightly oversized bale in its largest dimension.

The invention comprises the fact that the compact bale, once it has passed through the strapping apparatus, can be wrapped in an automatic, airtight manner in synthetic plastics sheeting.

A further characteristic is that the compact, strapped bale wrapped in an airtight manner in impermeable synthetic plastics sheeting forms a 3-dimensional body that is 1800 cm long, 1250 cm wide and 1350 cm high.

Finally, also, it has been envisaged in the invention that under the resistant plate provided with runoff through holes there is a conveyor belt for waste products and/or a collector for the liquids flowing through said through holes, all as a result of the actual pressing action performed by the pressing plate, which takes said liquids to a purification and/or recovery system, where appropriate, or directly to a legal dumping site.

### BRIEF DESCRIPTION OF THE DRAWINGS

In order to facilitate the understanding of the preceding ideas, there follows a description of a preferred embodiment of the invention, with reference to the accompanying illustrative drawings, in which:

FIG. 1, shows, in a simplified perspective view, an embodiment of a compacting chamber in a pressing machine provided with the improvements of the invention.

FIG. 2, is a sectional view in a horizontal plane showing the bottom wall of the compacting chamber.

FIG. 3, is a diagrammatic, exploded plan view of a pressing machine provided with the improvements of the invention, which shows the longitudinal structure separately, which comprises the compacting chamber, the pressing plate, the hopper and the driving means, the expulsion equipment and the output equipment.

FIG. 4, shows a similar view to the preceding figure, illustrating the three operative components of the machine in one of the two possible relative positions of the overall unit.

FIG. 5, shows, in a similar view to the preceding figures, another of the two relative positions of the overall unit.

FIG. 6, shows a diagrammatic representation of the pressing of a normal bale, when the pressing plate has still not reached the stopping point.

FIG. 7, shows a similar view to the preceding figure, when the pressing plate has reached its stopping point, the openable door has opened upwards and the action of the expulsion plate has started to move the compact bale towards the output equipment and the strapping device.

FIG. 8 is a similar view to FIGS. 6 and 7, showing the situation where excess disgregated material does not allow the pressing plate to reach its stopping point, whereby the machine becomes blocked.

FIG. 9 shows in a similar view to the preceding figures, a possible solution of provisionally increasing the compacting chamber capacity by partially retracting the expulsion plate.

FIG. 10, shows, continuing on from the preceding figure, when the pressing plate has reached its stopping point and a slightly longer bale than normal has been obtained.

FIG. 11, shows, similar to FIG. 8, the situation when the amount of excess material is greater than the amount that can be absorbed by the movement of the expulsion plate, whereby the openable door opens to allow the bale to expand longitudinally.

FIG. 12, shows, similar to preceding figures, the moment in FIG. 11 when the bale that is longer than normal is expelled.

FIG. 13, shows, a perspective view, of the mouth of the telescopic box that backs onto the openable door of the compacting chamber.

### DESCRIPTION OF SOME EMBODIMENTS OF THE INVENTION

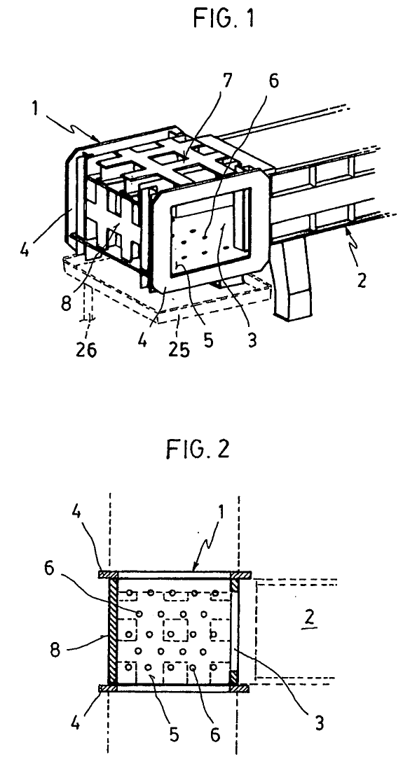

FIG. 1 shows a compacting chamber 1 of a pressing machine of which only part of the longitudinal structure 2 thereof can be seen, where the pressing plate with its cylinder and hydraulic equipment is housed and the feeding hopper is located.

As can be seen in FIG. 1, said compacting chamber 1 has a parallelepiped shape, with one medium inner face 3 which is open and on which the pressing plate acts, two smaller faces with respective frames 4 acting as flanges, a larger lower face 5 made up of a flat plate provided with runoff holes 6, a larger top face 7 and a medium outer face 8, with the latter two faces having a lattice structure in this figure.

FIG. 2 shows the plate forming larger lower face 5 of the compacting chamber with its runoff holes 6 and the mouth of medium inner face 3.

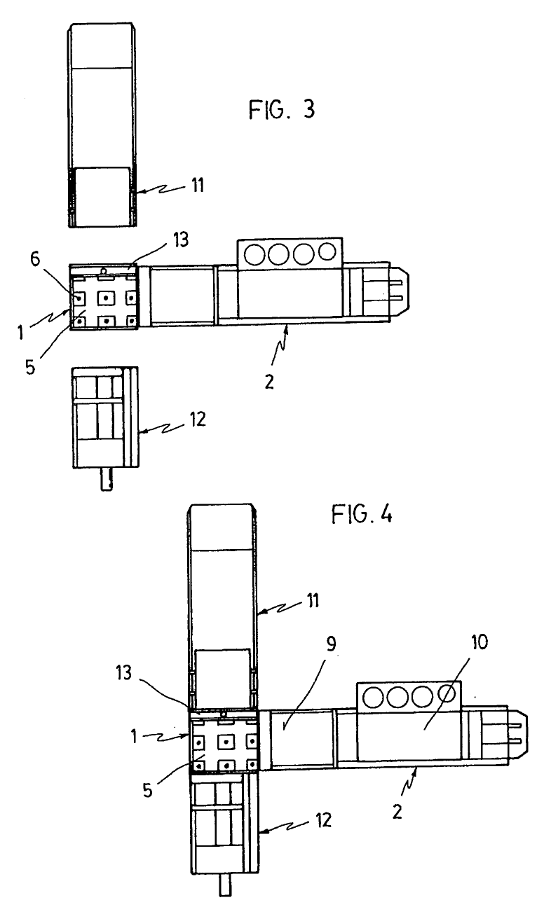

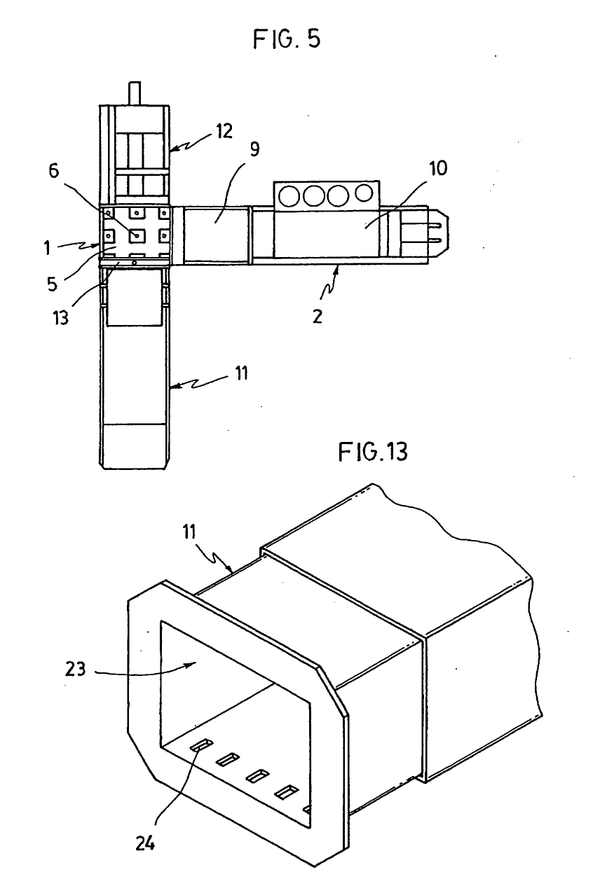

FIG. 3 shows, in the centre, the longitudinal structure 2, with the hopper 9 and the hydraulic unit 10 for driving the pressing plate, at the top thereof, the output equipment 11 is illustrated and at the bottom the expulsion equipment 12. Openable door 13 can be seen in the compacting chamber.

FIGS. 3 and 4 shows that said output 11 and expulsion 12 equipment can be placed to the right or to the left of longitudinal structure 2, whereby the three cited elements can be manufactured independently and then during the factory assembly they can be attached according to the space available.

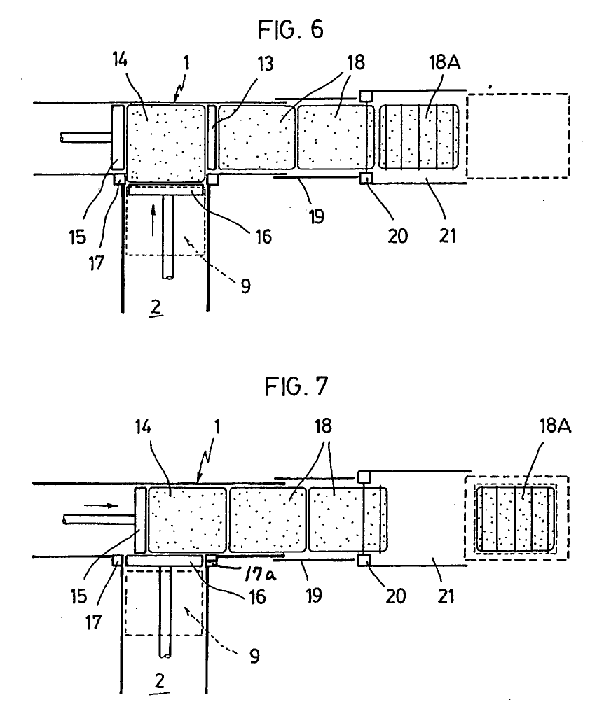

FIG. 6 shows the normal compacting operation of a normal volume of disgregated material 14, where expulsion plate 15 is stationary, pressing plate 16 is compressing and openable door 13 is closed.

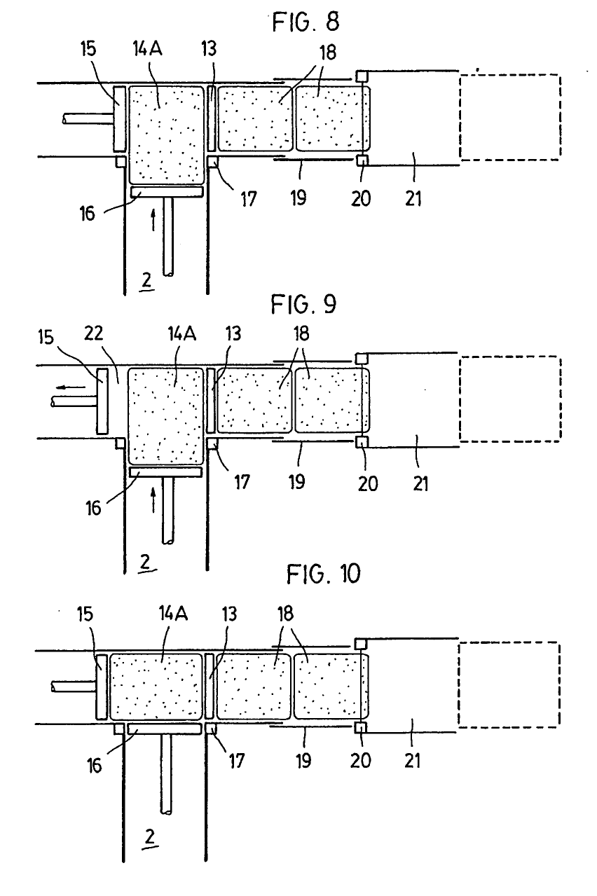

Once the pressing plate reaches the end stops 17 it reaches the stopping point, whereby openable door 13 opens and expulsion plate 15 is moved, as illustrated in FIG. 8, which determines that bale 18, recently compacted, pushes previous bales 18 through the inside of telescopic box 19 and acts upon the bale 18 that projects most from the strapping device 20, producing a new bale 18A on loading platform 21 ready for transporting.

FIG. 8 shows the case of compacting disgregated material that has an excess volume 14A while it is being compacted, which is greater than the normal capacity of compacting chamber 1, which excess volume 14A is determined by expulsion plate 15, the larger top and bottom and medium outer faces of chamber 1 and the pressing plate 16 which cannot reach the stopping point set by end stops 17.

Under these circumstances, where the pressing machine has two pressed bales 18 in its telescopic box 19, strapping device 20 and loading platform 21, the solution is adopted whereby expulsion plate 15 is retracted, as shown in FIG. 9, to create an auxiliary space 22 which can house the whole excess volume 14A and to enable pressing plate 16 to reach the stopping point set by end stops 17, as shown in FIG. 10, at which point openable door 13 is raised and the situations shown in FIGS. 6 and 7 are reached, with an extra long bale 14A.

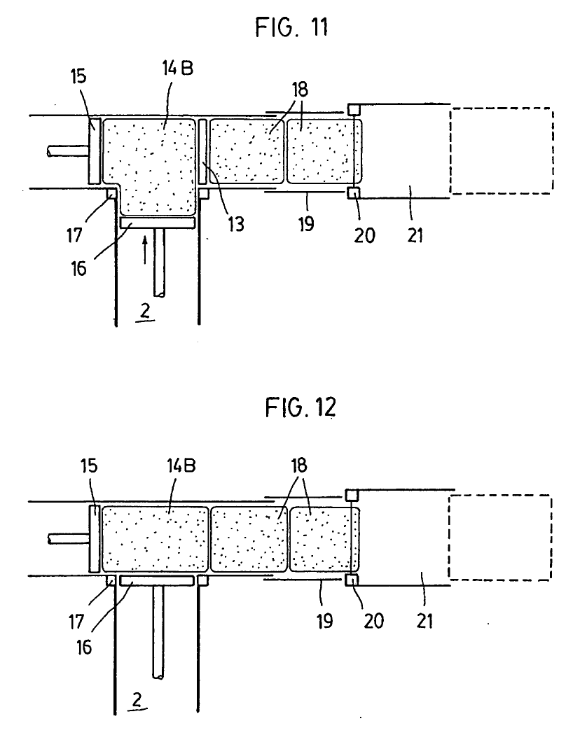

FIG. 11 shows the case of FIG. 8 where space 22 gained by retracting expulsion plate 15 is not enough for excess volume 14B, in which case openable door 13 is raised and the pressing plate is taken to end stops 17, as shown in FIG. 12, at which point expulsion plate 15 will move the mass of excess volume 14B towards the outside, without forming a bale or strapping it, where the disgregated material will be returned to hopper 9 thereby removing the obstacle that was preventing the bale from being compacted.

At all events, plate 5 with its runoff holes 6 will enable the squeezed liquids to be removed and collected in a collecting device that takes them to a legal drain.

Frames 4 provided on the smaller faces of compacting chamber 1 act as flanges that enable expulsion 12 and output 11 equipment to be attached with screws.

FIG. 13 shows a mouth 23 of telescopic box 11, which is the one that backs onto openable door 13 of compacting chamber 1, and in which through holes 24 are provided, preferably slot type holes, which allow the volume of air contained between a last bale 18 that has been compacted and expelled from compacting chamber 1, which is contained inside said telescopic box 11, and a recently compacted bale 14 that is being introduced into said telescopic box 11.

Means have been provided, as shown in FIG. 1, for collecting the liquids released as the bales are compacted and taking them to a legal dump and/or to a purifying plant, such as, for example, collection tray 25 and drain duct 26 shown in dotted lines in said FIG. 1. Similarly, and even simultaneously, a conveyor belt can be provided for the solid waste released via the through holes of compacting chamber 1.

1-9. (canceled)

10. Machine for making bales of disgregated material, comprising:
a compacting chamber having a substantially parallelepiped shape with a first wall that receives an action of a pressing plate, a second wall that is subjected to an action of an expulsion plate and a third wall having an output door that can be opened to expel a compact bale into a telescopic box located between said openable door and a strapping device,
wherein the compacting chamber further includes a runoff device for liquids contained in the material to be compacted and that flow during a pressing operation,
wherein the second and the third walls each include a frame which is an attachment flange that allows compact bale expulsion equipment and bale output equipment to be connected to either flange,
wherein the output door only moves in the vertical direction relative to the fourth wall, irrespective of whether the pressing plate has reached a stopping point,
wherein a capacity of the compacting chamber is variable according to a possible excess in an introduced mass of the material to be compacted, and
wherein the telescopic box has on at least one of the walls a first plurality of through holes located in proximity of the openable door.

11. Machine according to claim 10, wherein the runoff device includes a second plurality of through holes in the fourth wall.

12. Machine according to claim 10, wherein the compact bale expulsion equipment is attached to the flange of the second wall, while the compact bale output equipment, together with the strapping device thereof and an unloading station for the finished bales, is attached to the flange of said third wall.

13. Machine according to claim 10, wherein the compact bale expulsion equipment is attached to the flange of the third wall, while the compact bale output equipment, together with the strapping apparatus thereof and an unloading station for the finished bales, is attached to the flange of said second wall.

14. Machine according to claim 10, wherein the machine, in the event excess material is detected in the compacting chamber by a pressure switch, which excess material prevents the pressing plate from reaching the stopping point allows increased capacity in said compacting chamber, by retracting the expulsion plate to form a space, whereupon the excess material is introduced into the space by driving the pressing plate until it reaches the stopping point, wherein the output door, which closes the outlet of the chamber while the material making up the bale is compacted, opens, and the expulsion plate is activated, outputting an oversized bale.

15. Machine according to claim 14, wherein the machine, if the space created by retracting the expulsion plate is not enough to absorb the excess material, the outlet door is opened and, without interrupting the action of the pressing plate, the expulsion plate is activated, forming an oversized bale.

16. Machine according to claim 10, wherein the compacted bale, once it has gone through the strapping apparatus, is wrapped in an airtight manner.

17. Machine according to claim 16, wherein the compacted bale is approximately 1800 cm long, 1250 cm wide and 1350 cm high.

18. Machine according to claim 11, wherein under the fourth wall there is a collector for the flowing liquids, which takes said liquids to a recovery or purifying system, as appropriate or, directly, to a legal dump.
